(19) United States
(12) Patent Application Publication
(10) Pub. No.: US 2013/0068565 A1
(43) Pub. Date: Mar. 21, 2013

(54) Additionally improved device and method for converting gravitational force to energy

(71) Applicant: Steven Wayne Elliott, SR., Richmond, VA (US)

(72) Inventor: Steven Wayne Elliott, SR., Richmond, VA (US)

(21) Appl. No.: 13/200,059

(22) Filed: Sep. 16, 2011

(51) Int. Cl. F03G 3/00

(52) U.S. Cl. 185/28

(57) ABSTRACT

A device for converting gravitational force to energy. The device comprises a rotor (1). The rotor comprises a first outer chamber within which is contained a first displacement chamber (13), a second outer chamber within which is contained a second displacement chamber, and a outer shell (2). A piston (9) is slidably received in the casing between the first displacement chamber and the second displacement chamber, above the first displacement chamber. When the piston slides in the casing towards the first displacement chamber, displacement fluid (17) exits the first displacement chamber and enters the second displacement chamber, thereby causing the second displacement chamber to be heavier than the first displacement chamber. A pivot point (6), connected to the drive shaft, is provided wherein the rotor can rotate such that the second outer chamber becomes lower than the first outer chamber. A generator (19) is coupled to the shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a device, and method, for converting gravitational force to usable energy. More specifically, the present invention relates to a device, and method, for converting gravitational energy to rotational energy whereby the rotational energy can be harnessed for beneficial purposed with high efficiency.

Energy generation is vital to the survival and advancement of civilization. There is a continual desire to harness energy from non-depletable resources such as wind, tidal fluctuations and gravitational force. This desire will continue until the use of depletable resources, such as fossil fuels, is substantially reduced.

Harnessing energy from tidal fluctuations has been explored for many years. This method is limited by proximity to and ocean and by the corrosive nature of seawater. It is apparent to those of skill in the art that reducing mechanical losses, such as friction, is critical to efficient energy conversion. The corrosive nature of seawater is contrary to this desire.

The use of wind energy is widely used. This method s limited by the variability of wind. The unpredictable nature of wind requires that any wind based energy generation system have a supplemental energy source. With high winds a wind based energy generation system must be able to respond to the wind, typically by rotation, without generating the maximum amount of power, this is often referred to in the art as spilling. This non-energy producing rotation causes the various components to wear unnecessarily.

Harnessing energy from gravitational pull would be of great advantage. Gravitational pull is relatively constant at all times and in all conditions. This would allow energy generation systems to be virtually universal without regard for terrain, weather, or other uncontrollable events such as those related to geography and political systems. Harnessing gravitational pull would greatly benefit mankind.

Attempts to capture gravitational pull have met with limited success. Unbalanced rotating systems are described in U.S. Pat. Nos. 6,363,804, 5,921,133 and 4,333,548. The large number of moving parts and engaged gears reduces the efficiency of these systems. It is a desire to reduce the number of moving parts to increase efficiency of the overall system. A system based on fluid flow is described in U.S. Pat. No. 3,028,727 A method utilizing a threaded rod turned by a descending weight is described in U.S. Pat. No. 6,220,394. U.S. Pat. No. 4,509,329 does not describe displacement of fluid between cavities.

A system described by Elliott in U. S. Pat. Publ. No. 2004/0247459. This system has shown great promise as a system for transferring gravitation to energy. This advance has led to the realization that further improvements in the efficiencies would provide even greater opportunity for widespread use as an alternate energy source.

It has been an ongoing desire to harness gravitational forces efficiently. This goal has been achieved with the present invention.

### BRIEF SUMMARY OF THE INVENTION

It is an object of the present invention to provide a method of harnessing energy from gravity.

It is another object of the present invention to harness energy efficiently and without the necessity for auxiliary power.

A particular feature of the present invention is the simplicity of the inventive device and the minimal number of moving parts required to achieve the stated objects.

Another particular feature is the ability to utilize the present invention in any location without regard geography or environmental concerns.

Another feature of the present invention is the improvement in overall efficiency of the system with regards to the amount of energy generated by rotation.

These and other advantages, as will be realized, are provided in a device for converting gravitational force to energy. The device has a rotor and the rotor has a casing with a rotational axis, a first offset cavity and a second offset cavity wherein the first offset cavity and the second offset cavity are offset separately relative to the rotational axis a first cavity in the first end and a second cavity in the second end wherein the second cavity is in flow communication via a displacement fluid conduit with the first cavity. A piston is provided between the first cavity and the second cavity wherein when the piston slides within the casing in response to gravity towards the first end a displacement fluid exits the first cavity and enters the second cavity thereby causing the rotor to be heavier on the second end. The first cavity and the second cavity are divided into two or more corresponding sub-cavities and the displacement fluid conduit is similarly divided into corresponding sub-conduits. The first cavity sub-cavities, the displacement fluid conduit sub-conduits and the second cavity sub-cavities run end to end the length of the first cavity, the displacement fluid conduit, and the second cavity forming parallel veins that extend from one end of the machine to the other. The sub-cavities of the first cavity and the sub-cavities of the second cavity are of equal dimensions and parallel. As the piston slides in response to gravity towards the first end, the displacement fluid exits the lower sub-cavities, passes through the corresponding sub-conduits, and enters the corresponding second cavity sub-cavities. The Piston and displacement fluid move in a direction that is not co-linear with the force of gravity.

Yet another embodiment is provided in a rotor for converting gravitational force to rotational energy. The rotor has a first end and a second end. A first cavity is in the first end. A second cavity is in the second end wherein the second cavity is in flow communication through a machine conduit with the first cavity. The second cavity, the machine conduit, and the first cavity are divided into two or more sub-cavities and sub-conduits that together run the length of the second cavity, the displacement fluid conduit, and the first cavity. Sub-cavities when fluid filled are of equal dimensions and parallel one to another. A displacement fluid is provided which is selectively in the first cavity or the second cavity. A central pivot point is provided between the first end and the second end. A piston is provided wherein when the piston moves in response to the force of gravity a center of mass of the displacement fluid moves from the first cavity to the second cavity by displacing the displacement fluid in each sub-cavity sequentially until the displacement fluid in each and all of the sub-cavities of the first cavity has been fully displaced to each and all of the corresponding sub-cavities in the second cavity. The Piston and displacement fluid move in a direction that is not co-linear with the force of gravity.

### BRIEF DESCRIPTION OF THE DRAWINGS

FIG. 1 is an exterior three-dimensional view of one embodiment of a machine showing it as it would appear after rotation and before fluid displacement begins.

FIG. 2 shows the displacement weight moving down approximately 25% of its displacement distance with a corresponding movement in the piston. The piston consists of two box pistons connected to each end of the displacement weight and consequently to each other by way of a cable and pulley system that allows the full force generated by the displacement weight's vertical drop to be transferred and directed against the displacement fluid contained inside.

FIG. 3 shows the displacement weight moving down approximately 50% of its displacement distance displacing approximately 50% of the displacement fluid.

FIG. 4 shows the displacement weight moving down approximately 75% of its displacement distance displacing approximately 75% of the displacement fluid.

FIG. 5 shows the displacement weight as having fully transitioned downward fully displacing the displacement fluid not visible here from the lower end of the machine across the pivot point to the upper end. The upper end is heavier than the lower and rotates to reset at that position shown in FIG. 1.

FIG. 6 shows the how a series of these machines might be arranged along a drive shaft that would rotate with the rotation of the machines aligned thereon driving a generator the produce electricity.

FIG. 7 is a cross sectional view of the machine discussed in FIG. 1 where the machine has completed its rotation and is reset to begin the cycle of displacement and rotation. The cross sectional view reveals the veins created when the displacement chambers located at opposite ends of the machine are divided into one or more sub-chambers linked by a corresponding subdivision of the conduit.

FIG. 8 shows us a cross sectional view of the machine shown in FIG. 2 after one vein of displacement fluid has been displaced from the lower end of the vein to the opposite and upper end of the vein. The box piston blocks and traps the fluid in the first vein from exiting the first vein preventing the displaced fluid from exerting resistant downward backflow pressure against the piston which would slow or prevent the piston's continued downward movement.

FIG. 9 shows us a cross sectional view of the machine shown in FIG. 3 after two veins of displacement fluid has been displaced from the lower end of a second vein to the opposite and upper end of the same vein. Again, the box piston blocks and traps the fluid in the second vein as it did in the first vein preventing the displacement fluid from exiting the first and second veins and thereby exerting resistant downward backflow pressure against the piston which would otherwise slow or prevent the piston's continued downward movement.

FIG. 10 shows us a cross sectional view of the machine shown in FIG. 4 after the third vein of displacement fluid has been displaced from the lower end of a third vein to the opposite and upper end of the same vein. Again, the box piston blocks and traps the fluid in the third vein as it did in the first and second veins preventing the displacement fluid from exiting the first, second, and third veins which if not blocked and isolated from the subsequent displacement would exert resistant downward backflow pressure against the piston which would slow or prevent the piston's continued downward movement.

FIG. 11 shows us a cross sectional view of the machine shown in FIG. 5 after the forth vein of displacement fluid has been displaced from the lower end of a forth and last vein to the opposite and upper end of the same vein. Again, the box piston/channel blocker blocks and traps the fluid in the forth vein as it did in the first, second and third veins preventing the displacement fluid from exiting any of the veins and setting the condition for rotation and another sequential displacement. Note that the displacement weight has to exert enough pressure to displace one vein at a time rather than the entire body of fluid at once.

FIG. 12 is a cross sectional view of another embodiment of the present invention. Unlike the figure shown in FIG. 7 showing a casing with displacement chambers offset on opposite sides relative to the displacement conduit, the casing shown in FIG. 12, other than its box piston/channel blocker, is straight and consequently its end displacement chambers are not offset relative to the displacement conduit but instead stack one over the other. Otherwise, the machine in FIG. 12 operates in a similar manner as that shown in FIG. 7.

FIG. 13 shows us a cross sectional view of the machine after one vein of displacement fluid has been displaced from the lower end of the first vein to the opposite and upper end of the same vein as the displacement weights response to gravity is transferred directly to the box piston/channel blocker by way of cable and pulley allowing for the box piston/channel blocker's horizontal movement. As shown before in FIG. 8, the box piston blocks and traps the fluid in the first vein from exiting the first vein preventing the displaced fluid from exerting resistant downward backflow pressure against the piston which could slow or prevent the piston's continued horizontal movement.

FIG. 14 is a cross sectional view of the machine after two veins of displacement fluid has been displaced from the lower end of a second vein to the opposite and upper end of the same vein. Again, the box piston/channel blocker as it moves horizontally to displace the displacement fluid also blocks and traps the fluid in the second vein as it did in the first vein preventing the displacement fluid from exiting the first and second veins and thereby exerting resistant downward backflow pressure against the piston which would otherwise slow or prevent the piston's continued downward movement.

FIG. 15 shows us a cross sectional view of the machine shown after the third vein of displacement fluid has been displaced from the lower end of a third vein to the opposite and upper end of the same vein. Again, the box piston/channel blocker blocks and traps the fluid in the third vein as it did in the first and second veins preventing the displacement fluid from exiting the first, second, and third veins which if not blocked and isolated would exert resistant downward backflow pressure against the piston which would slow or prevent the piston's continued downward movement.

FIG. 16 is a cross sectional view of the forth vein after displacement fluid has been displaced from the lower end of a forth and last vein to the opposite and upper end of the same vein. Again, the box piston/channel blocker blocks and traps the fluid in the forth vein as it did in the first, second and third veins preventing the displacement fluid from exiting any of the veins and setting the condition for rotation about the pivot point. Resetting the rotor for another cycle. Note that the displacement weight has to exert enough pressure to displace one vein at a time rather than the entire body of fluid at once thereby reducing the weight of the displacement weight below the pivot point relative to the displaced weight above the pivot point.

### DETAILED DESCRIPTION OF THE INVENTION

The inventor of the present application has developed, through diligent research, a device capable of efficiently harnessing energy from gravitational pull. The inventor has also developed a method for incorporating such an inventive device in a system for generating energy from gravitational pull.

The invention will be described with reference to the figures forming a part of the present application. In the various figures similar elements are numbered accordingly.

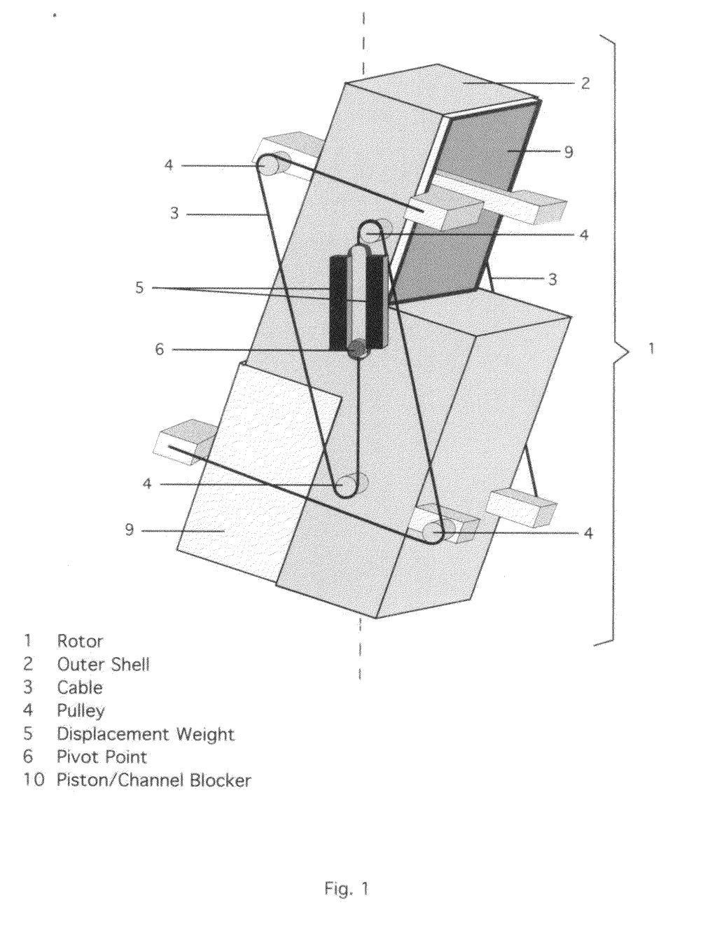

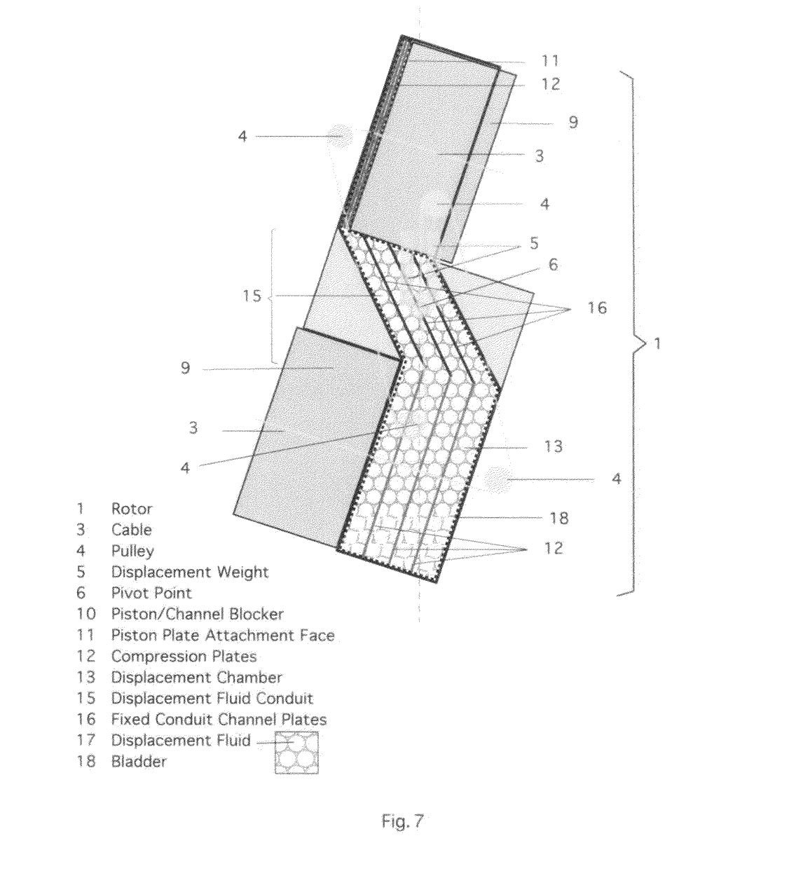

FIG. 7 is a cross sectional view of the rotor, 1, discussed in FIG. 1 where the machine has completed its rotation and is reset to begin the cycle of displacement and rotation. The cross sectional view reveals the veins created when the displacement chambers, 13, located at opposite ends of the machine are divided into one or more sub-chambers linked by a corresponding subdivision of the displacement conduit, 15.

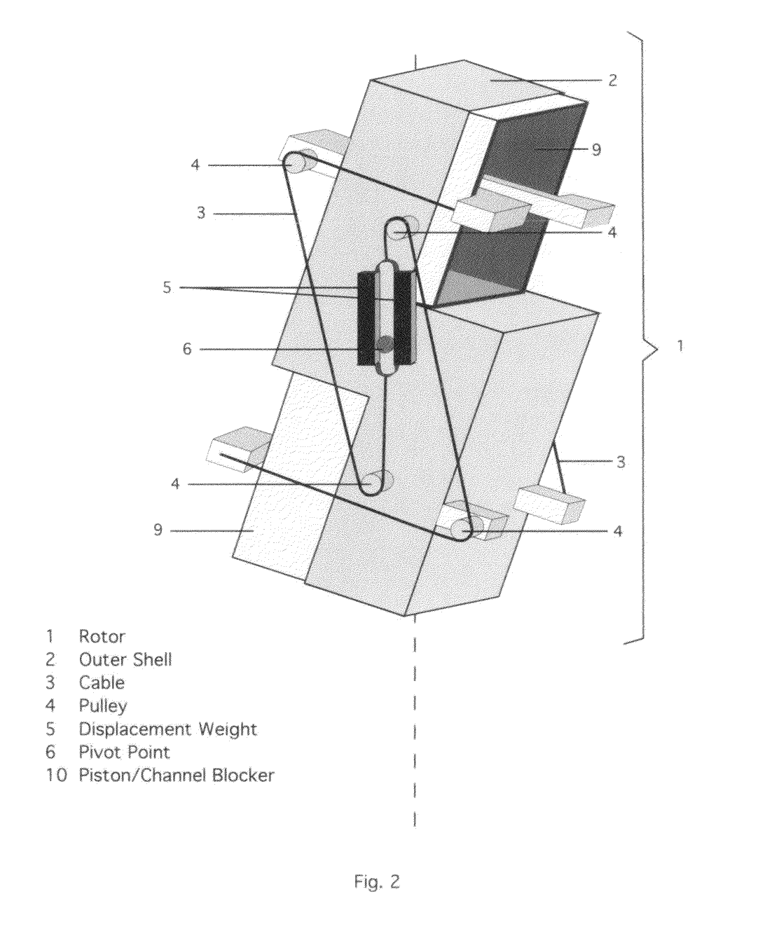

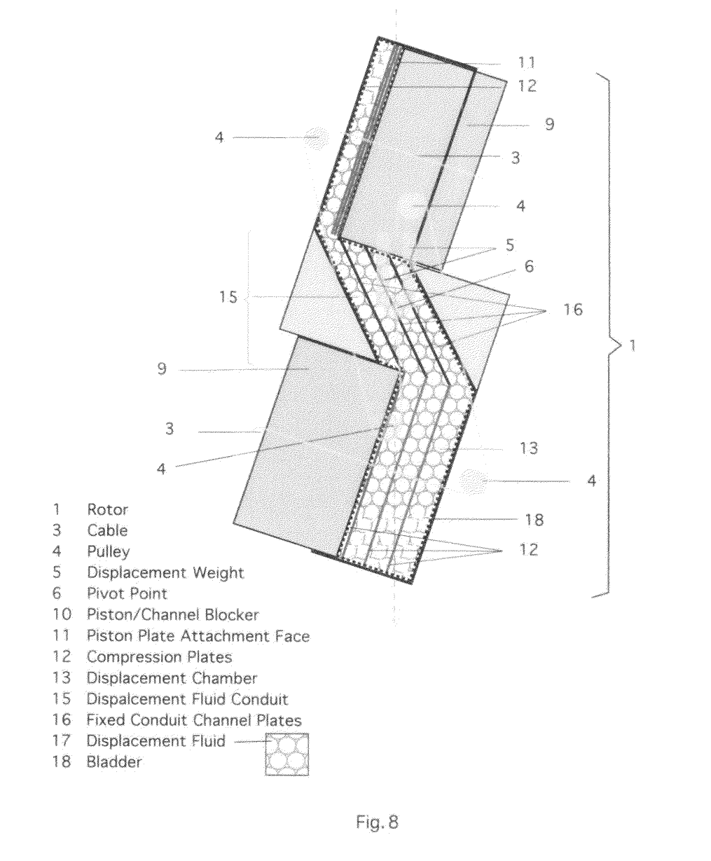

FIG. 8 shows us a cross sectional view of the rotor, 1, shown in FIG. 2 after one vein of displacement fluid, 17, has been displaced from the lower end of the vein to the opposite and upper end of the vein. The piston/channel blocker, 10, blocks and traps the fluid in the first vein from exiting the first vein preventing the displaced fluid, 17, from exerting resistant downward backflow pressure against the piston/channel blocker, 10, which would slow or prevent the piston's continued downward movement.

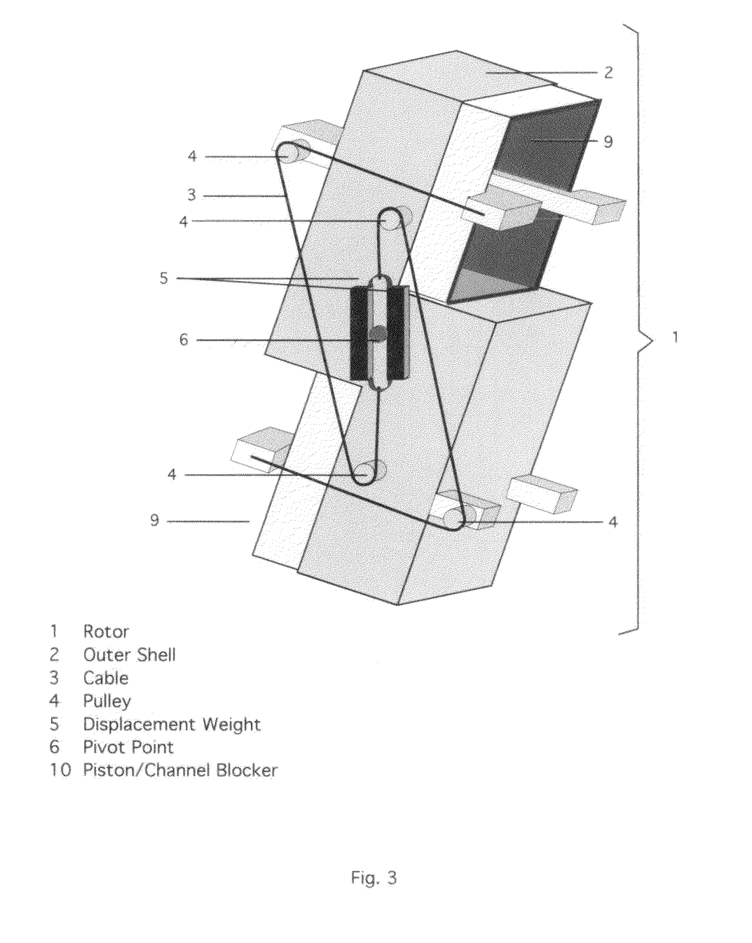

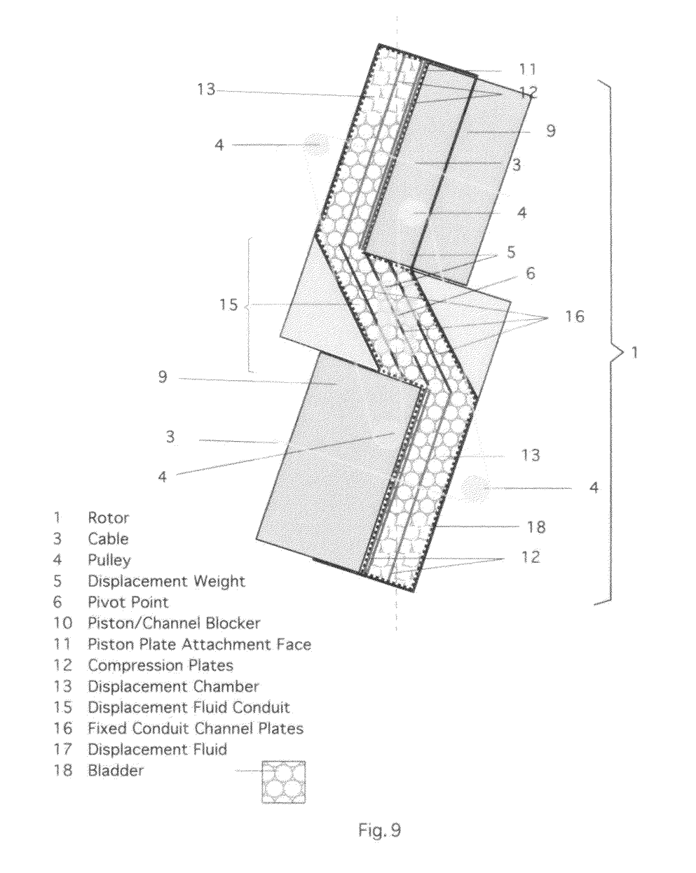

FIG. 9 shows us a cross sectional view of the rotor shown in FIG. 3 after two veins of displacement fluid, 17, has been displaced from the lower end of a second vein to the opposite and upper end of the same vein. Again, the piston/channel blocker, 10, blocks and traps the fluid in the second vein as it did in the first vein preventing the displacement fluid, 17, from exiting the first and second veins and thereby exerting resistant downward backflow pressure against the piston which would otherwise slow or prevent the piston/channel blocker's continued downward movement.

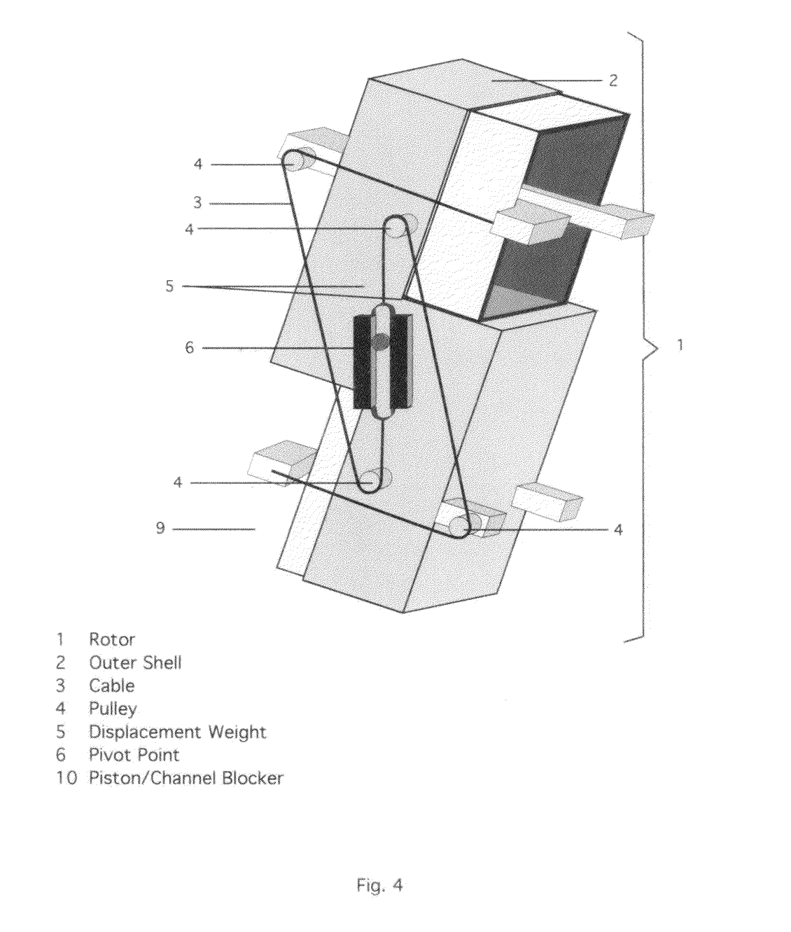

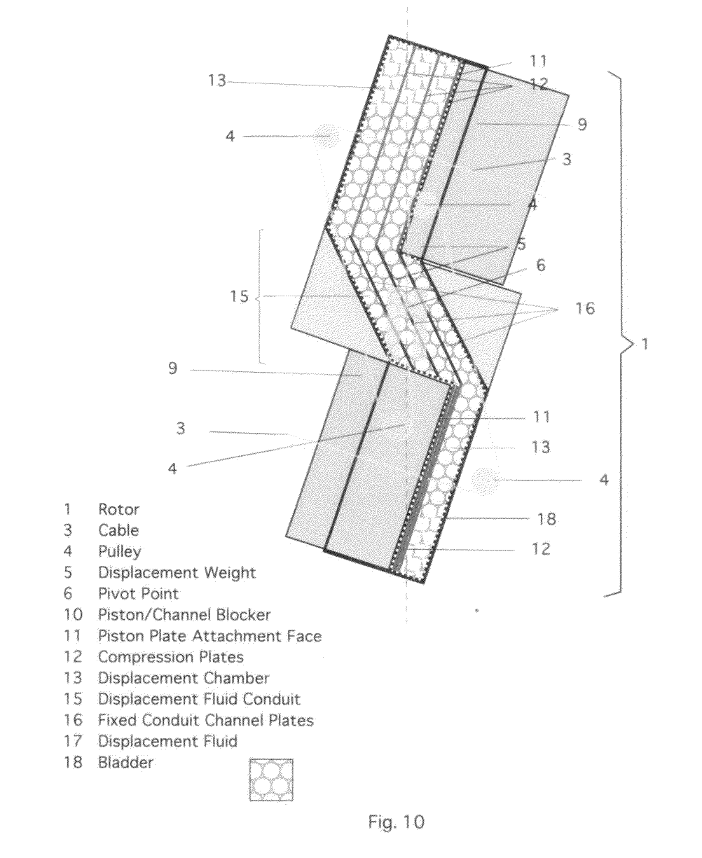

FIG. 10 shows us a cross sectional view of the rotor, 1, shown in FIG. 4 after the third vein of displacement fluid, 17, has been displaced from the lower end of a third vein to the opposite and upper end of the same vein. Again, the piston/channel blocker, 10, blocks and traps the fluid in the third vein as it did in the first and second veins preventing the displacement fluid, 17, from exiting the first, second, and third veins which if not blocked and isolated from the subsequent displacement would exert resistant downward backflow pressure against the piston/channel blocker, 10, which would slow or prevent the piston's continued downward movement.

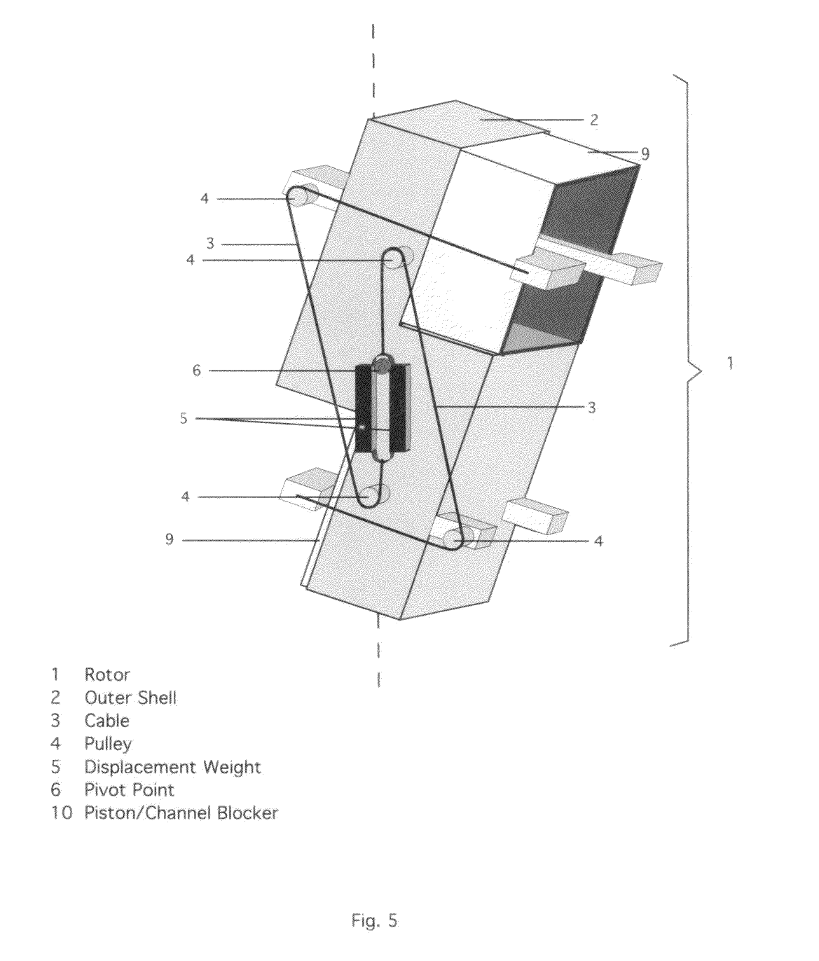

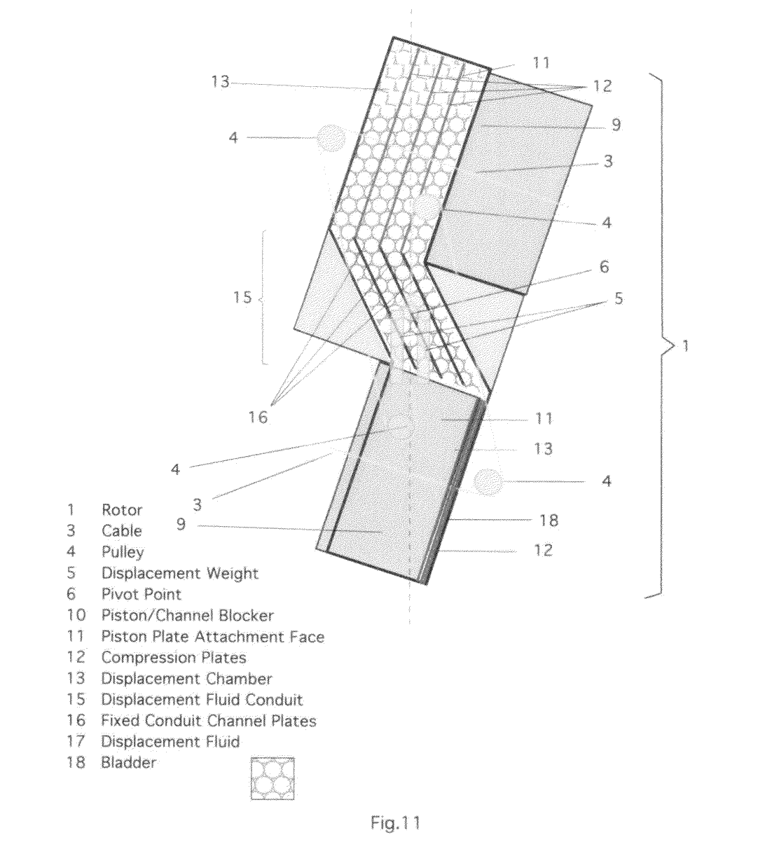

FIG. 11 shows us a cross sectional view of the rotor, 1, shown in FIG. 5 after the forth vein of displacement fluid, 17, has been displaced from the lower end of a forth and last vein to the opposite and upper end of the same vein. Again, the piston/channel blocker, 10, blocks and traps the fluid in the forth vein as it did in the first, second and third veins preventing the displacement fluid, 17, from exiting any of the veins and setting the condition for rotation and another sequential displacement. Note that the displacement weight, 5, has to exert enough pressure to over come friction and displace one vein at a time rather than the entire body of displacement fluid, 17, at once.

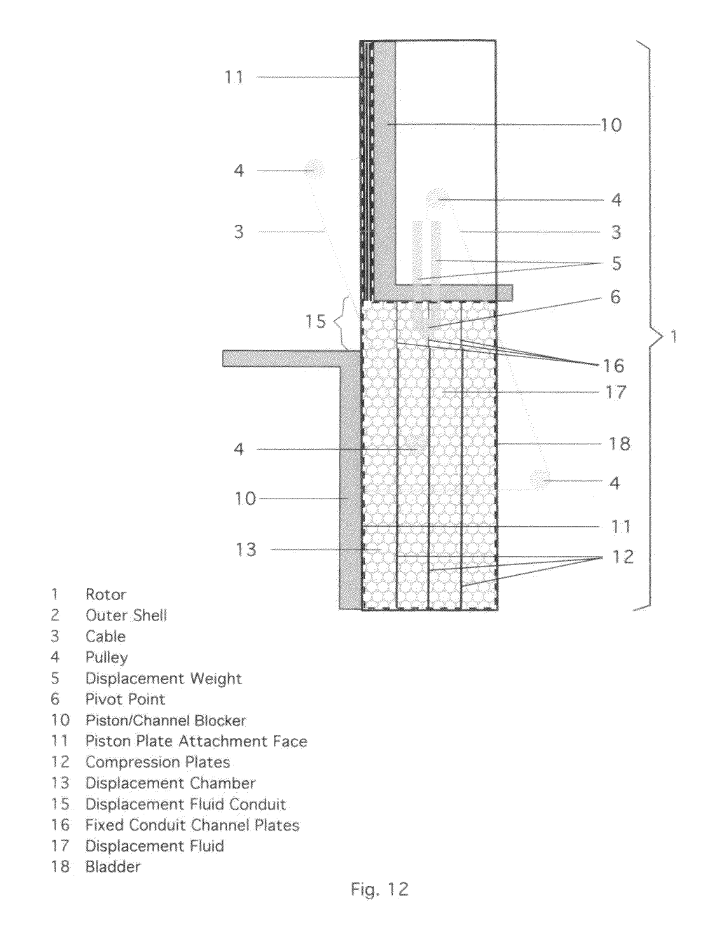

FIG. 12 is a cross sectional view of another embodiment of the present invention. Unlike the figure shown in FIG. 7 showing a casing with displacement chambers, 13, offset on opposite sides relative to the displacement conduit, 15, the casing shown in FIG. 12, other than its piston/channel blocker, 10, is straight and consequently its end displacement chambers, 13, are not offset relative to the displacement fluid conduit, 15, but instead stack one over the other. Otherwise, the machine in FIG. 12 operates in a similar manner as that shown in FIG. 7.

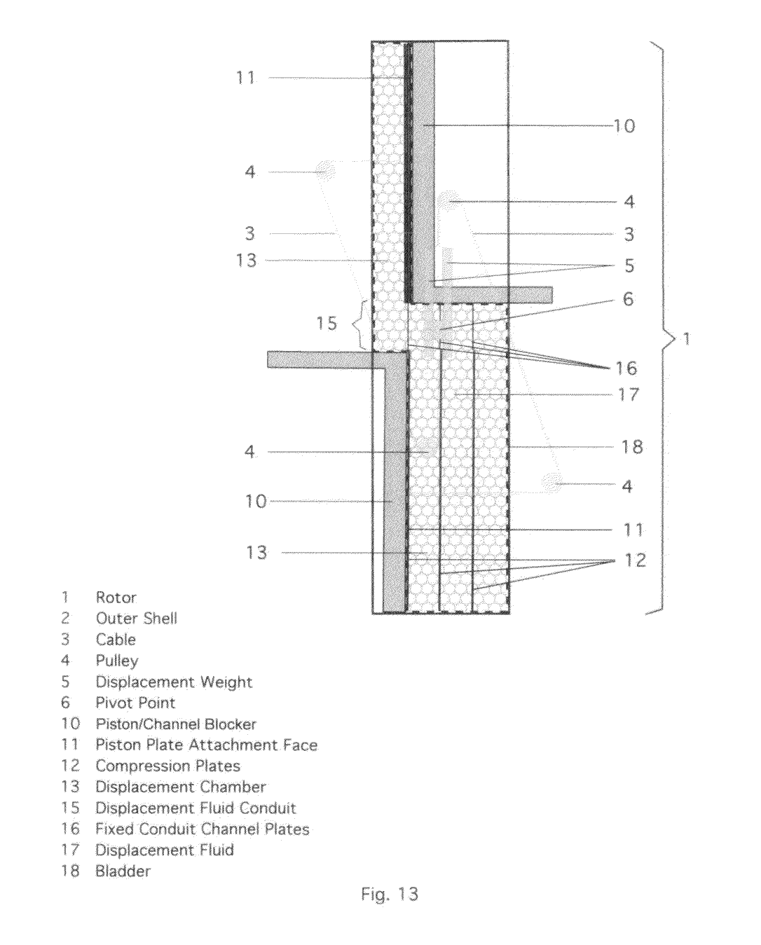

FIG. 13 shows us a cross sectional view of the machine after one vein of displacement fluid, 17, has been displaced from the lower end of the first vein to the opposite and upper end of the same vein as the displacement weights, 5, response to gravity is transferred directly to the piston/channel blocker, 10, by way of cable, 3, and pulley, 4, allowing for the piston/channel blocker's, 10, horizontal movement. As shown before in FIG. 8, the piston/channel blocker, 10, blocks and traps the fluid in the first vein from exiting the first vein preventing the displaced fluid, 17, from exerting resistant downward backflow pressure against the piston/channel blocker, 10 which could slow or prevent the piston's continued horizontal movement.

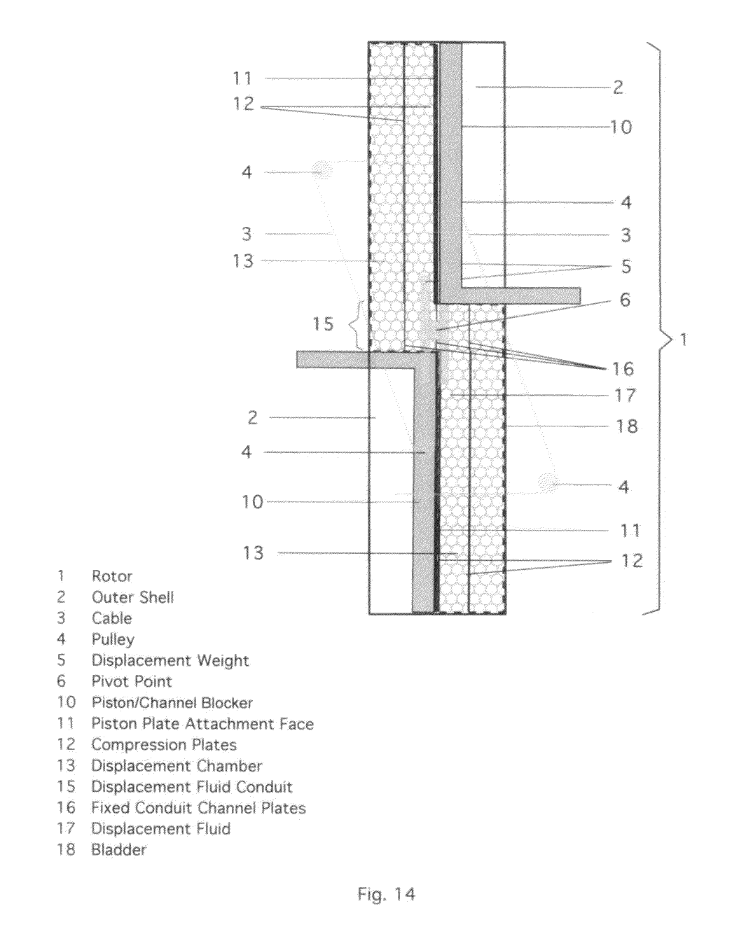

FIG. 14 is a cross sectional view of the rotor, 1, after two veins of displacement fluid, 17, has been displaced from the lower end of a second vein to the opposite and upper end of the same vein. Again, the piston/channel blocker, 10, as it moves horizontally to displace the displacement fluid also blocks and traps the fluid in the second vein as it did in the first vein preventing the displacement fluid, 17, from exiting the first and second veins and thereby exerting resistant downward backflow pressure against the piston/channel blocker which would otherwise slow or prevent the piston's continued downward movement.

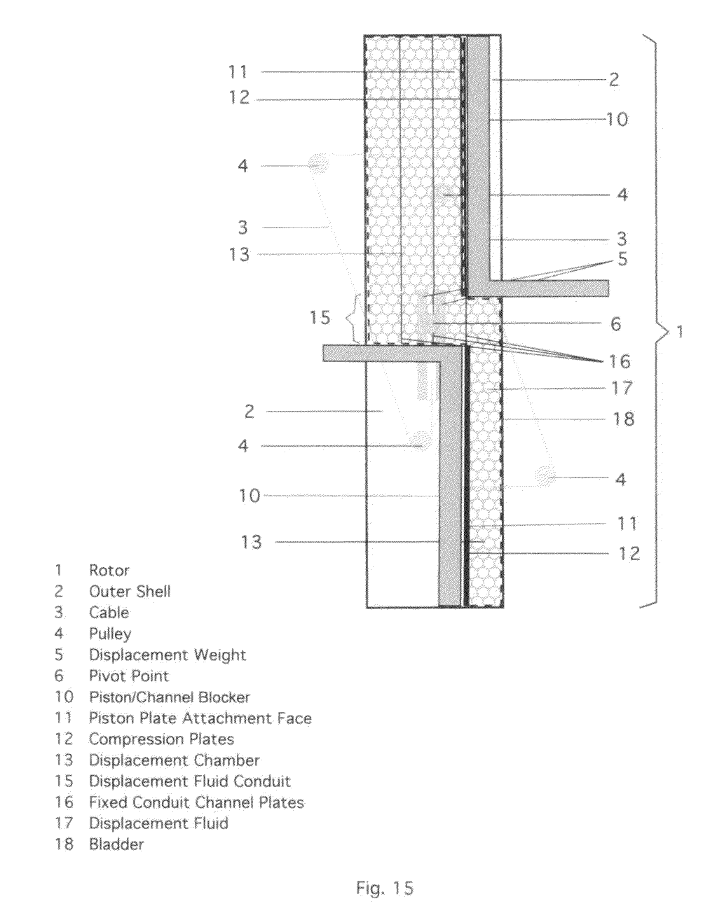

FIG. 15 shows us a cross sectional view of the machine shown after the third vein of displacement fluid, 17, has been displaced from the lower end of a third vein to the opposite and upper end of the same vein. Again, the piston/channel blocker blocks and traps the fluid in the third vein as it did in the first and second veins preventing the displacement fluid from exiting the first, second, and third veins which if not blocked and isolated would exert resistant downward backflow pressure against the piston/channel blocker which would slow or prevent the piston's continued downward movement.

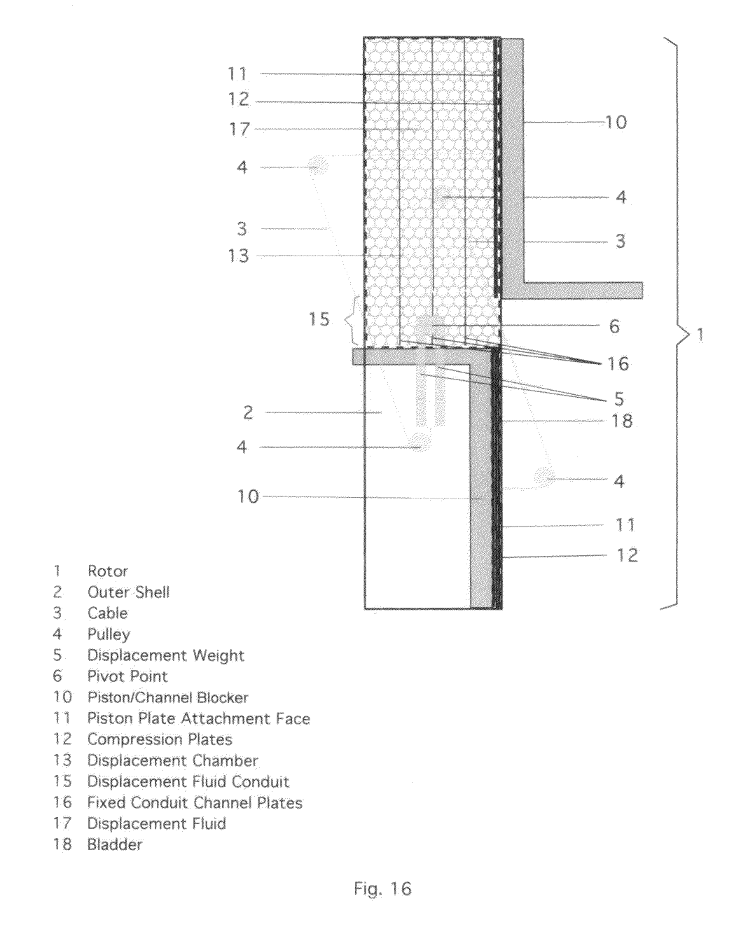

FIG. 16 is a cross sectional view of the forth vein after displacement fluid, 17, has been displaced from the lower end of a forth and last vein to the opposite and upper end of the same vein. Again, the piston/channel blocker blocks, 10, and traps the fluid in the forth vein as it did in the first, second and third veins preventing the displacement fluid, 17, from exiting any of the veins and setting the condition for rotation about the pivot point, 6, and resetting the rotor, 1, for another cycle. Note that the displacement weight, 5, has to exert enough pressure to displace one vein at a time rather than the entire body of fluid at once thereby reducing the weight of the displacement weight, 5, below the pivot point, 6, relative to the displaced weight, 5, above the pivot point, 6.

The displacement mechanism illustrated in FIG. 1 through FIG. 5 and used in FIG. 7 through FIG. 16, utilizes a collection of cables and pulleys, however, there are other mechanisms capable of coupling the movement of two elements in a directions that is co-linear. FIG. 1 through FIG. 5 utilizes cables, 3, on either side of the displacement weight, 5, and attached to the displacement weight, 5. The two displacement weights, 5, are coupled by way of the cable/pulley system and move in a direction that is co-linear. The cable, 3, goes around a pair of idle rollers or pulleys, 4, thereby translating the movement of the displacement weight(s), 5, into a direction non co-linear with the displacement direction of the box piston/channel blocker.

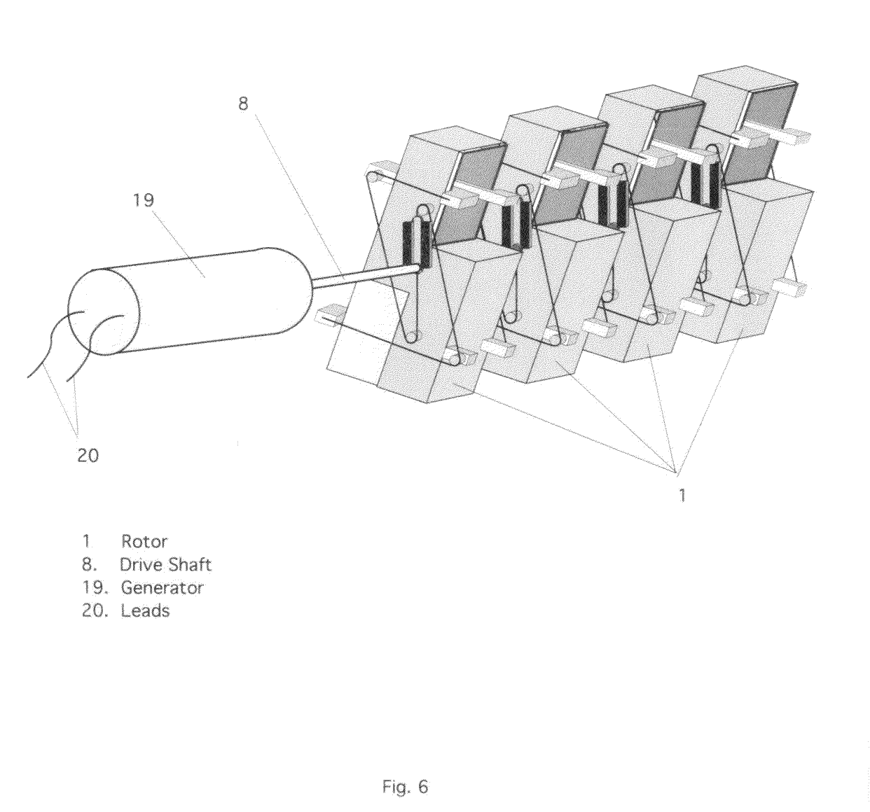

A system utilizing one embodiment of the present invention is provided in FIG. 6. In FIG. 6, a multiplicity of rotors, 1, are arranged in line, linearly, and attached to a generator, 19. The generator transports energy though leads, 20. Each rotor, 1, may be in a different rotational orientation from at least one other rotor. A drive shaft, 8, transfers the rotational motion from the assembly of rotors to the generator, 19. In one option, and perhaps a preferred option, the shaft may comprise a slip clutch whereby rotation of the shaft is in one rotational direction with the opposite rotation being free rotation. The primary drive shaft, 8, may be a continuous shaft passing through the series of rotors, 1, where a series of shafts each transferring rotational energy to the net shaft in the series towards the generator. However, the primary drive shaft, 8, may be a continuous shaft.

The function of the piston/channel blocker, 10, is to displace fluid from a lower chamber to the upper chamber. The pressure exerted by the piston/channel blocker, 10, derived from its connection to the direct drop displacement weight, 5, must be sufficient to displace the displacement fluid, 17, contained in each vein plus that required to overcome any friction associated with the displacement mechanism.

The displacement fluid, 17, and counter fluid are not limiting except that the total weight of displacement fluid displaced is higher than the weight of counter fluid displaced. Both the displacement fluid and the counter fluid are preferably selected from materials that flow well. Heavier displacement fluids are preferred. The fluid may include but not limited to various ingredients known in the art including stabilizes, surfactants, etc. Particularly suitable displacement fluids include water, mercury, and low viscosity high-density organic solvents. Water is the most preferred displacement fluid due to, among other things, cost and availability. Particularly suitable counter fluids are gases, particularly air.

The inner displacement chambers, 13, are in flow communication with each other and the outer chambers, represented by hollowed out Piston/channel blocker, 10, can also be in flow communication one with the other, if we chose to do so. It would be apparent that the inner chambers would not be in flow communication with the outer chambers. An optional, but preferred, seal or bladder, 18, is provided to separate the inner chambers from the outer chambers. The seal or bladder, 18, may be a ring around the piston as commonly employed for separating chambers above and below a piston.

The generator, FIG. 6, is any device suitable for converting rotational energy to a usable energy form. Particularly preferred generators, 19, produce electricity or pressure. Electrical generators are well known and further elaboration herein is not necessary. Pressure generators are known to include fluid pumps such as water pumps, hydraulic pumps, air pumps and the like wherein the moving fluid is further used to accomplish a task. An electrical generator is most preferred.

Bladders, 18, are not limited by their material of construction with the exception of the flexibility that must be sufficient for the bladder to expand and extract without hindering the mass transfer. The manner in which the bladder is attached is also not critical to the present invention.

Flow communication, in the context of the present invention, is specific to a mechanism for transferring fluid from one vicinity to the other, In general, the area containing fluid has a fixed volume within complimentary regions wherein one contracts concurrently with one expanding or, if a solid, where one exchanges position to a complimentary and opposing region, and the flow communication is a preferably fixed volume region there between.

The invention has been described with particular emphasis on the preferred embodiments. It would be realized from the teachings herein that other embodiments, alterations, and configurations could be employed without departing from the scope of the invention which is more specifically set forth in the which are appended hereto.

Claimed is:

1. A rotor with an offset center of balance for converting gravitational force to rotational energy comprising:
a first and second end;
a first cavity in said first end;
a second cavity in said second end wherein said second cavity is in flow communication with said first cavity;
a first cavity and second cavity divided into parallel sub-cavities of equal number and dimensions.
a first cavity and second cavity where each sub-cavity of the second cavity is in flow communication with the corresponding sub-cavity of the first cavity.
a central pivot point between said first end and said second end;
a piston between said first end and said second end wherein said piston moves between said first end and said second end said piston center of gravity and said rotor center of gravity moves in a direction which is not co-linear with the force of gravity; and
a shaft parallel to said central pivot.

2. A device for generating energy from gravitational pull comprising;
a casing comprising:
a rotational axis
a first offset cavity;
a second offset cavity wherein said first offset cavity and said second offset cavity are offset separately relative to said rotational axis;
a first cavity and second cavity divided into parallel sub-cavities of equal number and dimensions.
a first cavity and second cavity where each sub-cavity of the second cavity is in flow communication with the corresponding sub-cavity of the first cavity.
a piston slidably attached inside said casing and capable of sliding due to
gravity;
a displacement fluid capable of moving between said first offset cavity and said second offset cavity as said piston slides within said casing.

3. This device of claim 2 wherein said piston slides in a direction which is non-linear with respect to said gravitational pull.

4. The rotor of claim 2 further comprising a displacement weight which moves towards said force of gravity and causes said piston to move.

5. The rotor of claim 4 wherein said displacement weight and said piston move in directions which are not co-linear.

6. The device of claim 3 wherein said piston has opposing lobes.

7. A rotor for converting gravitational force to rotational energy comprising:
a first end and a second end;
a first cavity in said first end;
a second cavity in said second end wherein said second cavity is in flow communication with said first cavity;
a displacement fluid selectively in said first cavity or said second cavity;
a first cavity and second cavity divided into parallel sub-cavities of equal number and dimensions.
a first cavity and second cavity where each sub-cavity of the second cavity is in flow communication with the corresponding sub-cavity of the first cavity.
a central pivot point between said firs end and said second end; and
a piston wherein when said piston moves in response to the force of gravity a center of mass of said displacement fluid moves from said first cavity to second cavity a direction which is not co-linear with said force of gravity.

8. The rotor of claim 7 wherein when said piston moves a center of mass of said piston moves in a direction which is not co-linear with said force of gravity.

9. The rotor of claim 7 further comprising a displacement weight which moves towards said force of gravity and causes said piston to move.

10. The rotor of claim 9 wherein said displacement weight and said piston move in directions which are not co-linear.
